(19) United States
(12) Patent Application Publication
(10) Pub. No.: US 2025/0334078 A1
(43) Pub. Date: Oct. 30, 2025

(54) ACTIVE CONTROL OF GEARBOX CASE PRESSURE

(71) Applicant: Hamilton Sundstrand Corporation, Charlotte, NC (US)

(72) Inventors: Ryan Shook, Loves Park, IL (US); Ryan Susca, Windsor, CT (US); Matthew Slayter, Loves Park, IL (US)

(21) Appl. No.: 18/647,614

(22) Filed: Apr. 26, 2024

(51) Int. Cl. F02C 7/32; F02C 7/06; F16H 57/027

(52) U.S. Cl. CPC F02C 7/32; F02C 7/06; F16H 57/027; F05D 2260/4031; F05D 2260/605; F05D 2260/609

(57) ABSTRACT

A system with active pressure control includes a sensor, a valve, and a controller. The sensor interfaces with and senses a pressure within a cavity of system component. The valve is disposed along a gas discharge path in fluid communication with a gas outlet port of a separator. The controller varies open area of the valve based on the pressure measured by the sensor.

### BACKGROUND

The present disclosure relates to lubrication systems, and more particularly, to lubrication systems with active control of pressure within the system.

Lubrication systems circulate lubricating fluids throughout machines using one or more pumps, sumps, and reservoirs, among other possible components, which depend on maintaining certain operational pressures and flow rates at various locations with the system. Some applications require the system to operate in variable ambient conditions, or lower pressure conditions, that can degrade performance of certain components of the system. For example, gas turbine engines have lubrications system that can include scavenge pumps operating at or near ambient pressures exterior to the gas turbine engine. As altitude increases, the pressure at the scavenge pump decreases. To ensure safe operation, the lubrication system is not operated above an attitude ceiling. Further development is desirable to increase the operational capability of lubrication systems.

### SUMMARY

An active pressure control subsystem according to an example embodiment of this disclosure includes a sensor, a valve, and a controller. The sensor is disposed to measure pressure within a component of a system containing a mixture of gas and lubricating fluid. The valve is disposed along a gas discharge path of the system, which operates to discharge gas separated from the gas-fluid mixture. The controller varies the open area of the valve based on a signal received from the sensor.

A system according to an example embodiment of this disclosure includes pressurized gas source, a component, a sensor, a separator, a valve, and a controller. The component includes a cavity containing fluid in communication with the pressurized gas source to discharge a gas-fluid mixture. The sensor is configured to measure pressure within the cavity. The separator is operable to separate gas and fluid from the gas-fluid mixture. The separator includes an inlet port, a gas outlet port, and a fluid outlet port. The inlet port fluidly communicates with the cavity to receive the gas-fluid mixture. The gas outlet port fluidly communicates with a gas discharge path for discharging gas separated from the gas-fluid mixture. The fluid outlet port discharges fluid separated from the gas-fluid mixture. The valve is disposed along the gas discharge path. The controller is operable to vary an open area of the valve based on the pressure measured by the sensor.

A lubrication system according to another example embodiment of this disclosure includes a bleed air source, a gearbox, a sensor, a separator, a valve, and a controller. The gearbox includes a cavity containing fluid in communication with the bleed air source to discharge a gas-fluid mixture. The sensor is configured to measure pressure within the cavity. The separator is operable to separate gas and fluid from the gas-fluid mixture. The separator includes an inlet port, a gas outlet port, and a fluid outlet port. The inlet port fluidly communicates with the cavity to receive the gas-fluid mixture. The gas outlet port fluidly communicates with a gas discharge path for discharging gas separated from the gas-fluid mixture. The fluid outlet port discharges fluid separated from the gas-fluid mixture. The valve is disposed along the gas discharge path. The controller is operable to vary an open area of the valve based on the pressure measured by the sensor.

A method of operating a system with active pressure control includes determining, using a sensor, a pressure within a cavity of a component containing a gas-fluid mixture. The method further includes comparing, using a controller, the pressure to a target pressure and varying an open area of a valve, using the controller, to maintain the pressure within the cavity at the target pressure. The target pressure is greater than an ambient pressure and less than the pressure of a pressurized gas source. The valve is disposed along a gas discharge path connected to a gas outlet of a separator.

### BRIEF DESCRIPTION OF THE DRAWINGS

FIG. 1 is a schematic view of a system with active pressure control.

FIG. 2 is a flowchart describing a method of operating the system with active pressure control.

### DETAILED DESCRIPTION

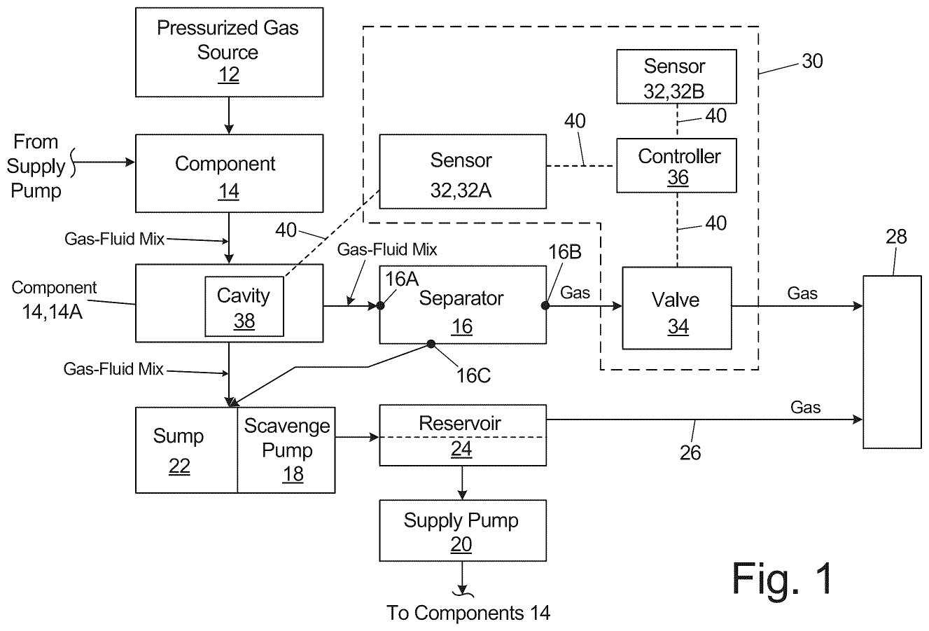

FIG. 1 is a schematic view of an example system. System 10 includes pressurized gas source 12, one or more components 14, separator 16, scavenge pump 18, supply pump 20, sump 22, reservoir 24, vent line 26, and gas discharge path 28. System 10 further includes active pressure control subsystem 30, which includes one or more sensors 32, valve 34, and controller 36. System 10 provides lubricating fluid to a machine, a vehicle, and components thereof. For example, system 10 can be a lubrication system for a gas turbine engine that provides lubricating fluid to one or more of a bearing compartment, a gearbox, a seal cavity, one or more pumps, reservoirs, and/or sumps, among other possible components.

Pressurized gas source 12 is a source of pressurized gas that is used to aid operation of the system 10. For instance, pressurized gas within source 12 can be used to manage a differential pressure across seals that retain the lubrication fluid within system 10. Pressurized gas from source 12 can be used to drive lubrication fluid through system 10. Examples of pressurized gas source 12 can include gas discharged from a compressor or a pressurized storage container, among other potential sources of pressurized gas.

As shown, pressurized gas source 12 is a source of bleed air from a gas turbine engine. Bleed air can be extracted from one or more compressor stages of the gas turbine engine. Bleed air from source 12 can be used to maintain desired differential pressure across one or more seals of lubrication system 10 and/or to pressurize one or more cavity (e.g., cavity 38) of lubrication system 10 to promote flow of lubricating fluid. As depicted, cavity 38 of component 14 receives bleed air from pressurized gas source 12.

Components 14 are devices in the lubrication path of system 10. At least one of components 14 (e.g., component 14A) includes cavity 38 within which lubrication fluid collects and/or through which lubrication fluid flows. Examples of component 14 can include a gearbox casing, a bearing compartment, a sump, and a reservoir, among other possible components 14. As depicted, component 14 is a gearbox (e.g., an auxiliary gearbox) of the gas turbine engine. In other examples, component 14 can be a bearing compartment, a seal cavity, or other component of gas turbine engine receiving lubrication fluid. Lubrication fluid collects within components 14 and mixes with bleed air received from pressurized gas source 12 to form the gas-fluid mixture.

Separator 16 is any device operable to separate gas (e.g., air) from the lubrication fluid (e.g., oil). Example separators can include an active aerator, a passive acrator, or a centrifugal separator, among other possible devices. Separator 16 includes inlet 16A, gas outlet 16B, and fluid outlet 16C. The mixture of gas and lubrication fluid is received at inlet 16A of separator 16. In operation, separator 16 actively or passively separates the gas from the lubricating fluid. The gas is discharged through gas outlet 16B, and the lubrication fluid discharges through fluid outlet 16C.

Sump 22 is a cavity or reservoir positioned within system 10 to collect lubrication fluid. For example, sump 22 may be located at a low-pressure location within system 10 and/or at a location where lubricating fluid tends to collect under gravity when operating in an intended orientation. Sump 22 fluidly communicates with cavity 38 of component 14.

Scavenge pump 18 and supply pump 20 are each a variable displacement pump, a constant displacement pump, a centrifugal pump, a gear pump, or other suitable pump for circulating lubricating fluid within system 10. Scavenge pump 18 fluidly communicates with sump 22 and reservoir 24. In operation, scavenge pump 18 transfers lubricating fluid from within sump 22 to reservoir 24. Supply pump 20 fluidly communicates with reservoir 24 and cavity 38 of component 14. In operation, supply pump 20 transfers lubricating fluid from within reservoir 24 to one or more components of system 10 (e.g., component 14).

Reservoir 24 is any cavity, container, or tank containing stored lubrication fluid. Reservoir 24 communicates with a discharge of scavenge pump 18 and an inlet to supply pump 20.

Gas discharge path 28 fluidly connects gas outlet 16B of separator 16 to an ambient environment exterior to system 10. Similarly, vent line 26 communicates with an air space within sump 22, fluidly connecting sump 22 to the ambient environment.

Pressurized gas source 12, cavity 38 of component 14, separator 16, sump 22, scavenge pump 18, supply pump 20 are interconnected by one or more fluid and/or gas passages. Passages can include any combination or tube, conduit, pipe, hose, internal passage, cavity, chamber, or manifold, among other potential fluidic and/or gas passages. Further, system 10 may have additional components 14 not depicted by FIG. 1.

In operation, the pressurized gas source 12 drives the lubricating fluid through system 10 and into cavity 38 of component 14, creating a mixture of gas and lubricating fluid (e.g., a gas-fluid mixture). A portion of the gas-fluid mixture from within cavity 38 communicates with inlet 16A of separator 16 while another portion of the gas-fluid mixture communicates with sump 22. Separator 16 discharges gas from the gas-fluid mixture through gas outlet 16B and into gas discharge path 28, and discharges fluid from the gas-fluid mixture through fluid outlet 16C and into sump 22.

Active pressure control subsystem 30 includes one or more sensors 32, valve 34, and controller 36. Active pressure control subsystem 30 maintains a target pressure within at least cavity 38 of component 14. In the following examples, active pressure control subsystem 30 maintains a pressure within cavity 38 at a target pressure as described below. In other examples, active pressure control subsystem 30 can be configured to control multiple cavities at the same target pressure, or different target pressures.

Sensor 32 is any resistive, capacitive, piezoelectric, or optical transducer configured to output a signal representative of pressure. In some examples, sensor 32 is an absolute pressure transducer configured to measure an absolute pressure in which a reference pressure of sensor 32 is a vacuum. In other examples, sensor 32 is a gauge pressure transducer configured to measure gauge pressure in which the reference pressure of sensor 32 is standard atmospheric pressure. In still other examples, sensor 32 can be configured as a differential pressure transducer in which the reference pressure is another pressure region. In some instances, the differential pressure transducer is configured such that an ambient pressure exterior to system 10 is the reference pressure. Sensor 32 is installed to measure pressure within cavity 38 of component 14.

Valve 34 includes a valve element and valve actuator operable to vary the open area of valve 34 based on a control signal. Examples of valve 34 include a butterfly valve, a ball valve, a gate valve, a needle valve, or a solenoid valve, among other possible valve types. Valve actuator can be a hydraulic actuator, electrical actuator, or an electro-hydraulic actuator, among other suitable actuator types. Valve actuator includes analog and/or digital control inputs and may include analog and/or digital feedback channels. Control inputs can receive a command signal from controller 36 representative of a desired valve position or open area. Feedback channels, when present, output an analog and/or digital feedback signal representative of a current valve position or open area. The open area of valve 34 can vary between one hundred percent (i.e., a fully open valve position) open to an intermediate open area greater than zero percent (i.e., a fully closed valve position).

Controller 36 is an electronic device that is connected to one or more sensors 32 and valve 34 via a wireless and/or a wired connection as indicated by dashed lines 40. Controller 36 can be a computer, an engine control unit, a control module integrated with an engine control unit, a control module discrete from an engine control unit, and a full authority digital engine (or electronics) controller, among other possible examples. While the following disclosure refers to a controller (singular), the method and functions attributed to a single controller can be distributed among multiple controllers 36 in other examples. That is, functionality attributed herein to controller 36 can, in certain examples, be distributed among multiple controllers 36.

In a first example, active pressure control subsystem 30 includes sensor 32, valve 34, and controller 36. Sensor 32 is an absolute pressure transducer that communicates with and senses an absolute pressure of cavity 38. Sensor 32 outputs and controller 36 receives a signal representative of the absolute pressure within cavity 38. Based on the signal, controller 36 outputs a command signal to valve 34, which operates to vary a position of valve 34 and, hence, an open area thereof. The controller 36 causes the open area of valve 34 to vary in order to maintain a target pressure within cavity 38.

In a second example, active pressure control subsystem 30 includes first sensor 32A, second sensor 32B, valve 34, and controller 36. First sensor 32A is a differential pressure transducer that communicates with and senses a differential pressure of cavity 38 relative to a reference region. In some examples, the reference region is an ambient environment exterior to lubrication system 10 described, in part, by an ambient pressure. In other examples, the reference region can be another location within the lubrication system 10, or within gas turbine engine more generally. Second sensor 32B is an absolute pressure transducer that communicates with and senses a pressure within the reference region. First sensor 32A outputs and controller 36 receives a first signal representative of the differential pressure measured within cavity 38 relative to the reference region. Second sensor 32B outputs and controller 36 receives a second signal representative of the absolute pressure measured within the reference region. Based on the first signal and the second signal, controller 36 outputs a command signal to valve 34, which operates to vary a position of valve 34 and, hence, an open area thereof. For instance, controller 36 may determine an absolute pressure within cavity 38 based on the first signal and the second signal and vary the open area of valve 34 based on the calculated absolute pressure within cavity 38.

In each example, controller 36 causes the open area of valve 34 to vary in order to maintain a target pressure within cavity 38. Reducing the open area of valve 34 restricts gas exiting through gas discharge path and increases pressure within cavity 38, and increases pressure at an inlet of scavenge pump 18. Increasing the open area of valve 34 permits gas to exit gas discharge path more freely and decreases pressure within cavity 38, and decreases pressure at the inlet of scavenge pump 18. The target pressure is a value greater than an ambient pressure exterior to lubrication system 10 and less than a supply pressure of pressurized gas source 12 (e.g., the bleed air pressure at the extraction port). In some examples, the target pressure is less than the supply pressure of pressurized air source 12 by a threshold differential amount. The threshold differential pressure accounting for system losses associated with proper flow of gas (e.g., bleed air) throughout lubrication system 10. In some examples, the target pressure may vary based on the operational state of system 10, and/or one or more ambient parameters (e.g., ambient pressure, ambient temperature). Accordingly, the pressure within cavity 38 and at an inlet to scavenge pump 18 is maintained at or near the target pressure, thereby permitting system 10 to operate at lower ambient pressures than otherwise possible without active pressure control subsystem 30.

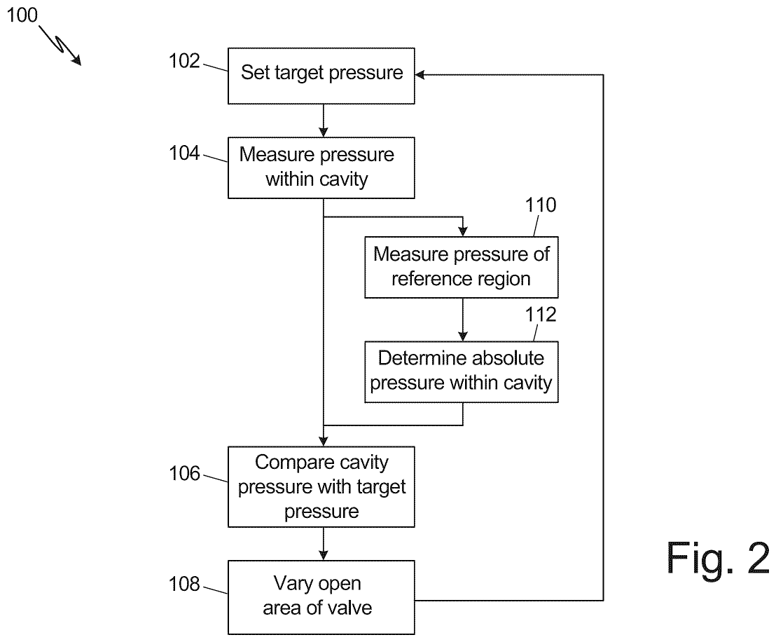

FIG. 2 is a flow chart describing a method of operating system 10. Method 100 includes steps 102, 104, 106, and 108. In some examples, method 100 includes steps 110 and 112. The sequence depicted is for illustrative purposes only and is not meant to limit the method 100 in any way as it is understood that the portions of the method can proceed in a different logical order, additional or intervening portions can be included, or described portions of the method can be divided into multiple portions, or described portions of the method can be omitted without detracting from the described above.

In step 102, controller 36 selects a target pressure. Target pressure can be a constant value in some examples, which is greater than an ambient pressure and less than a supply pressure of pressurized gas source 12, or less than the supply pressure by a threshold differential pressure. In other examples, target pressure is continuously or periodically updated based on an operational state of system 10 or, in the case of a gas turbine engine lubrication system, based on an operational state (e.g., power level) of the gas turbine engine.

In step 104, a pressure within cavity 38 is determined using sensor 32. Sensor 32 outputs and controller 36 receives a signal representative of the pressure within cavity 38. Sensor 32 may output signal on a continuous basis, or periodically, at a predetermined sampling rate. In step 106, controller 36 compares the pressure of cavity 38 with the target pressure to determine an error. Based on the measured pressure and the target pressure, controller 36 outputs a command signal to valve 34 in step 108, causing valve 34 to vary an open area thereof to achieve the target pressure.

In some examples, sensor 32 is a differential pressure sensor that outputs a first signal indicative of a differential pressure between cavity 38 and a reference region. In such examples, controller 36 determines an absolute pressure within cavity 38 prior the comparison with the target pressure. In step 110, a pressure within a reference region is determined by second sensor 32B. Second sensor 32B outputs and controller 36 receives a second signal indicative of the pressure within the reference region. In step 112, controller 36 determines the absolute pressure within cavity 38 based on the first signal of sensor 32 and the second signal of second sensor 32. Subsequently, controller 36 performs step 108, outputting a command signal to valve 34 to cause valve 34 to vary an open area thereof to achieve the target pressure.

Steps 102, 104, 106 and 108, or steps 102, 104, 106, 108, 110, and 112 are performed repeatedly as needed to maintain cavity 38 at target pressure throughout operation of system 10. Accordingly, the pressure within cavity 38 and at an inlet to scavenge pump 18 can be maintained at a pressure greater than an ambient pressure.

### Discussion of Possible Embodiments

The following are non-exclusive descriptions of possible embodiments of the present invention.

A System with Active Pressure Control

A system according to an example embodiment of this disclosure includes, among other possible things, a pressurized gas source, a component, a separator, and an active pressure control subsystem. The component comprises a cavity containing fluid in communication with the pressurized gas source to discharge an air-oil mixture. The separator is operable to separate gas and fluid from the gas-fluid mixture. The separator includes an inlet port, a gas outlet, and a fluid outlet. The inlet port fluidly communicates with the cavity to receive the gas-fluid mixture. The gas outlet port fluidly communicates with a gas discharge path for discharging gas separated from the gas-fluid mixture. The fluid outlet port for discharging fluid separated from the gas-fluid mixture. The active pressure control subsystem includes a sensor, a valve, and a controller. The sensor is configured to measure pressure within the cavity. The valve is disposed along the gas discharge path. The controller is operable to vary an open area of the valve based on the pressure measured by the sensor.

The system of the preceding paragraph can optionally include, additionally and/or alternatively, any one or more of the following features, configurations and/or additional components.

A further embodiment of the foregoing system, wherein the controller can cause the valve to vary the open area to maintain a target pressure within the cavity greater than an ambient pressure exterior to the system.

A further embodiment of any of the foregoing systems, wherein the controller can cause the valve to vary the open area to maintain the target pressure within the cavity less than a supply pressure of the pressurized gas source.

A further embodiment of any of the foregoing systems, wherein the target pressure can be less than the supply pressure by at least a threshold differential pressure.

A further embodiment of any of the foregoing systems, wherein the controller can vary the target pressure based on an operational state of the system.

A further embodiment of any of the foregoing systems, wherein the sensor can be an absolute pressure transducer configured to output to the controller a signal indicative of the absolute pressure within the cavity.

A further embodiment of any of the foregoing systems, wherein the sensor can be a differential pressure transducer configured to output to the controller a signal indicative of a differential pressure between the pressure within the cavity and an ambient pressure exterior to the system.

A further embodiment of any of the foregoing systems can include a second sensor configured to measure an ambient pressure exterior to the system.

A further embodiment of any of the foregoing systems, wherein the second sensor can be an absolute pressure transducer that outputs to the controller a second signal indicative of the ambient pressure.

A further embodiment of any of the foregoing systems, wherein the controller can determine an absolute pressure within the cavity based on the first signal and the second signal.

A further embodiment of any of the foregoing systems can include a scavenge pump in fluid communication with the cavity and the fluid outlet port.

A further embodiment of any of the foregoing systems, wherein the controller can vary the open area of the valve to increase the pressure within the cavity and at an inlet to the scavenge pump.

A Lubrication System for a Gas Turbine Engine with Active Pressure Control

A lubrication system for a gas turbine engine according to an example embodiment of this disclosure includes, among other possible things, a bleed air source, a gearbox, a separator, and an active pressure control subsystem. The gearbox comprises a cavity containing fluid in communication with the bleed air source to discharge a gas-fluid mixture. The separator is operable to separate gas and fluid from the gas-fluid mixture. The separator includes an inlet port, a gas outlet, and a fluid outlet. The inlet port fluidly communicates with the cavity to receive the gas-fluid mixture. The gas outlet port fluidly communicates with a gas discharge path for discharging gas separated from the gas-fluid mixture. The fluid outlet port for discharging fluid separated from the gas-fluid mixture. The active pressure control subsystem includes a sensor, a valve, and a controller. The sensor is configured to measure pressure within the cavity. The valve is disposed along the gas discharge path. The controller is operable to vary an open area of the valve based on the pressure measured by the sensor.

The lubrication system of the preceding paragraph can optionally include, additionally and/or alternatively, any one or more of the following features, configurations and/or additional components.

A further embodiment of the foregoing lubrication system, wherein the controller can cause the valve to vary the open area to maintain a target pressure within the cavity greater than an ambient pressure exterior to the system.

A further embodiment of any of the foregoing systems, wherein the controller can cause the valve to vary the open area to maintain the target pressure within the cavity less than a supply pressure of the bleed air source.

A further embodiment of any of the foregoing systems, wherein the target pressure can be less than the supply pressure by at least a differential pressure.

A further embodiment of any of the foregoing systems, wherein the controller can vary the target pressure based on the operational state of the gas turbine engine.

A further embodiment of any of the foregoing systems, wherein the sensor can be an absolute pressure transducer configured to output to the controller a signal indicative of the pressure within the cavity.

A further embodiment of any of the foregoing systems, wherein the sensor can be a differential pressure transducer configured to output to the controller a signal indicative of a differential pressure between the pressure within the cavity and an ambient pressure exterior to the system.

A further embodiment of any of the foregoing systems can include a second sensor configured to measure an ambient pressure exterior to the system.

A further embodiment of any of the foregoing systems, wherein the second sensor can be an absolute pressure transducer that outputs to the controller a second signal indicative of the ambient pressure.

A further embodiment of any of the foregoing systems, wherein the controller can determine an absolute pressure within the cavity based on the first signal and the second signal.

A further embodiment of any of the foregoing systems can include a scavenge pump in fluid communication with the cavity and the fluid outlet port.

A further embodiment of any of the foregoing systems, wherein the controller can vary the open area of the valve to increase the pressure within the cavity and at an inlet to the scavenge pump.

A further embodiment of any of the foregoing systems can include a sump in fluid communication with the cavity of the gearbox.

A further embodiment of any of the foregoing systems, wherein the scavenge pump can be in fluid communication with the sump.

A further embodiment of any of the foregoing systems can include a vent line in fluid communication with an air region of the sump and the gas discharge region.

A Method of Operating a System with Active Pressure Control

A method of operating a system according to an example embodiment of this disclosure includes, among other possible things, determining a pressure within a cavity of a component containing a gas-fluid mixture by using a sensor. The method further includes comparing, using a controller, the pressure to a target pressure and varying an open area of a valve, using the controller, to maintain the pressure within the cavity at the target pressure. The target pressure is greater than an ambient pressure and less than a source pressure of a pressurized gas source. The valve is disposed along a gas discharge path connected to a gas outlet of a separator.

The method of the preceding paragraph can optionally include, additionally and/or alternatively, any one or more of the following features, configurations and/or additional components.

A further embodiment of the foregoing method, wherein the system is a lubrication system for a gas turbine engine.

A further embodiment of any of the foregoing methods, wherein the component is a gearbox.

A further embodiment of any of the foregoing methods, wherein the pressurized gas source is a bleed air source.

A further embodiment of any of the foregoing methods can include selecting, using the controller, the target pressure.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A system comprising:
a pressurized gas source;
a component comprising a cavity containing fluid in communication with the pressurized gas source to discharge a gas-fluid mixture;
a separator operable to separate gas and fluid from the gas-fluid mixture, the separator comprising:
an inlet port fluidly communicating with the cavity to receive the gas-fluid mixture;
a gas outlet port fluidly communicating with a gas discharge path for discharging gas separated from the gas-fluid mixture; and
a fluid outlet port for discharging fluid separated from the gas-fluid mixture; and
an active pressure control subsystem comprising:
a sensor configured to measure a pressure within the cavity;
a valve disposed along the gas discharge path; and
a controller operable to vary an open area of the valve based on the pressure measured by the sensor.

2. The system of claim 1, wherein the controller causes the valve to vary the open area to maintain a target pressure within the cavity greater than an ambient pressure exterior to the system.

3. The system of claim 2, wherein the controller causes the valve to vary the open area to maintain the target pressure within the cavity less than a supply pressure of the pressurized gas source.

4. The system of claim 3, wherein the target pressure is less than the supply pressure by at least a threshold differential pressure.

5. The system of claim 4, wherein the controller varies the target pressure based on an operational state of the system.

6. The system of claim 1, wherein the sensor is an absolute pressure transducer configured to output to the controller a signal indicative of the absolute pressure within the cavity.

7. The system of claim 1, wherein the sensor is a differential pressure transducer configured to output to the controller a signal indicative of a differential pressure between the pressure within the cavity and an ambient pressure exterior to the system.

8. The system of claim 7, wherein the active pressure control subsystem further comprises:
a second sensor configured to measure an ambient pressure exterior to the system, wherein the second sensor is an absolute pressure transducer that outputs to the controller a second signal indicative of the ambient pressure, and wherein the controller determines an absolute pressure within the cavity based on the first signal and the second signal.

9. The system of claim 1, further comprising:
a scavenge pump in fluid communication with the cavity and the fluid outlet port;
wherein the controller varies the open area of the valve to increase the pressure within the cavity and at an inlet to the scavenge pump.

10. A lubrication system for a gas turbine engine, the lubrication system comprising:
a bleed air source;
a gearbox in fluid communication with the bleed air source to discharge a gas-fluid mixture;
a separator operable to separate gas and fluid from the gas-fluid mixture, the separator comprising:
an inlet port fluidly communicating with the cavity to receive the gas-fluid mixture;
a gas outlet port fluidly communicating with a gas discharge path for discharging gas separated from the gas-fluid mixture; and
a fluid outlet port for discharging fluid separated from the gas-fluid mixture;
an active pressure control subsystem comprising:
a sensor configured to measure a pressure within the cavity;
a valve disposed along the gas discharge path; and
a controller operable to vary an open area of the valve based on the pressure measured by the sensor.

11. The lubrication system of claim 10, wherein the controller causes the valve to vary the open area to maintain a target pressure within the cavity greater than an ambient pressure exterior to the system.

12. The lubrication system of claim 11, wherein the controller causes the valve to vary the open area to maintain the target pressure within the cavity less than a supply pressure of the bleed air source.

13. The lubrication system of claim 12, wherein the target pressure is less than the supply pressure by at least a differential pressure.

14. The lubrication system of claim 13, wherein the controller varies the target pressure based on an operational state of the gas turbine engine.

15. The lubrication system of claim 10, wherein the sensor is an absolute pressure transducer configured to output to the controller a signal indicative of the pressure within the cavity.

16. The lubrication system of claim 10, wherein the sensor is a differential pressure transducer configured to output to the controller a signal indicative of a differential pressure between the pressure within the cavity and an ambient pressure exterior to the system.

17. The lubrication system of claim 16, the active pressure control subsystem further comprising:
a second sensor configured to measure an ambient pressure exterior to the system, wherein the second sensor is an absolute pressure transducer that outputs to the controller a second signal indicative of the ambient pressure, and wherein the controller determines an absolute pressure within the cavity based on the first signal and the second signal.

18. The lubrication system of claim 10, further comprising:
a scavenge pump in fluid communication with the cavity and the fluid outlet port;
wherein the controller varies the open area of the valve to increase the pressure within the cavity and at an inlet to the scavenge pump.

19. The lubrication system of claim 18, further comprising:
a sump in fluid communication with the cavity of the gearbox, wherein the scavenge pump is in fluid communication with the sump; and
a vent line in fluid communication with an air region of the sump and the gas discharge region.

20. A method for operating a lubrication system of a gas turbine engine, the method comprising:
determining, using a sensor, a pressure within a cavity of a gearbox containing a gas-fluid mixture; and
compare, using a controller, the pressure to a target pressure; and
varying a valve open area, using the controller, to maintain the pressure within the cavity at the target pressure;
wherein the target pressure is greater than an ambient pressure and less than a source pressure of a bleed air source; and
wherein the valve is disposed along a gas discharge path connected to a gas outlet of a separator.
